(19) United States
(12) Patent Application Publication
(10) Pub. No.: US 2025/0185683 A1
(43) Pub. Date: Jun. 12, 2025

(54) TEA FOR WEIGHT LOSS AND LIPID-LOWERING AND PREPARATION METHOD THEREOF

(71) Applicant: Changde Jizhi Biological Technology Co., Ltd, Changde (CN)

(72) Inventor: Xinqiao HE, Changde (CN)

(21) Appl. No.: 18/534,570

(22) Filed: Dec. 9, 2023

(51) Int. Cl. A23F 3/14; A23F 3/24

(52) U.S. Cl. CPC A23F 3/14; A23F 3/24

(57) ABSTRACT

A tea for weight loss and lipid-lowering and a preparation method thereof, related to the field of medical technologies, are provided. The tea includes tea-leaf, tea seed shell, water hyacinth, petiole of dasheen, Rosa rugosa polysaccharides and Crataegus pinnatifida flavone. The Research has shown that the tea can accelerate fat burning, inhibit fat synthesis, regulate gut microbiota, and synergistically achieve weight control with safety and without side effects.

### TECHNICAL FIELD

The disclosure relates to the field of medical technologies, and particularly to a tea for weight loss and lipid-lowering and a preparation method thereof.

### BACKGROUND

Tea-leaf, commonly referred to as tea for short, generally includes leaves and buds of tea plants. The components of the tea-leaf include catechins, cholesterone, caffeine, inositol, folic acid, and pantothenic acid, which are beneficial for health. Tea beverage made from the tea-leaf is one of the three major beverages in the world.

The tea-leaf was originated in China and was first used as a sacrifice. But it has been used as a vegetable since the late Spring and Autumn period, developed into medicinal use in the middle of the Western Han Dynasty, and developed into a premium beverage for the court in the late Western Han Dynasty. It became popular among the folks as a common beverage after the Western Jin Dynasty. The earliest artificial tea cultivation site was discovered at the Yuyao Tianluoshan relic, Zhejiang, with a history of over 6000 years. Tea drinking began in China. The leaves of tea are leathery, round or oval in shape, and can be soaked in hot water for making the tea to drink. Types of tea include six categories based on variety, production method, and product appearance. According to the season, tea can be divided into spring tea, summer tea, autumn tea, and winter tea. Various types of raw or refined tea are further processed to obtain reprocessed tea, including flower tea, compressed tea, extracted tea, medicinal and health tea, tea food, and beverages containing tea.

Obesity not only affects body shape and leads to imbalance of intestinal flora in human bodies, but also brings a variety of complications such as diabetes, hypertension, and cerebrovascular accident, endangering human health. With the continuous deepening of people's understanding of the dangers of the obesity, more and more people are participating in the weight loss team. The commonly used weight loss methods include dietary therapy, exercise therapy, behavioral therapy, medication therapy, and surgical methods. The dietary therapy is a basic method of the obesity therapy. Based on this, many weight loss products have emerged.

At present, there are a large number of weight loss products on the market. As of April 2020, 392 health foods with weight loss functions were found on the Drugdataexpy and a large number of sports nutrition and functional foods that cannot be found. However, the quality of numerous weight loss products is also uneven, some expensive, no weight loss effect; some weight loss effect is good, but there are significant side effects; some add illegal chemical ingredients, jeopardizing the physical and mental health of the weight loss population.

### SUMMARY

In response to the shortcomings of the prior art, the disclosure provides a tea for weight loss and lipid-lowering and a preparation method thereof. The tea can accelerate fat burning, inhibit fat synthesis, regulate gut microbiota, and achieve the effect of weight control in synergy, with safety and without side effects.

The technical solutions are as follows.

A tea for weight loss and lipid-lowering includes 85-95 parts by weight of tea-leaf, 1-8 parts by weight of tea seed shell, 1-5 parts by weight of water hyacinth, 1-3 parts by weight of petiole of dasheen, 1-4 parts by weight of Rosa rugosa polysaccharides, and 2-6 parts by weight of Crataegus pinnatifida flavone.

In an embodiment, 85 parts by weight of the tea-leaf, 1 part by weight of the tea seed shell, 1 part by weight of the water hyacinth, 1 part by weight of the petiole of dasheen, 1 part by weight of the Rosa rugosa polysaccharides, and 2 parts by weight of the Crataegus pinnatifida flavone.

In an embodiment, the tea includes 90 parts by weight of the tea-leaf, 4 parts by weight of the tea seed shell, 3 parts by weight of the water hyacinth, 2 parts by weight of the petiole of dasheen, 2 parts by weight of the Rosa rugosa polysaccharides, and 4 parts by weight of the Crataegus pinnatifida flavone.

In an embodiment, 95 parts by weight of the tea-leaf, 8 parts by weight of the tea seed shell, 5 parts by weight of the water hyacinth, 3 parts by weight of the petiole of dasheen, 4 parts by weight of the Rosa rugosa polysaccharides, and 6 parts by weight of the Crataegus pinnatifida flavone.

In an embodiment, a preparation method of a tea for weight loss and lipid-lowering includes a preparation method of Rosa rugosa polysaccharides including:
degreasing Rosa rugosa, extracting polysaccharides from the Rosa rugosa after the degreasing to obtain a polysaccharide extraction solution, performing a solid-liquid separation on the polysaccharide extraction solution to obtain an aqueous solution of Rosa rugosa polysaccharide, and drying the aqueous solution of Rosa rugosa polysaccharide to obtain the Rosa rugosa polysaccharides.

In an embodiment, a preparation method of a tea for weight loss and lipid-lowering includes a preparation method of Crataegus pinnatifida flavone including:
freezing and crushing Crataegus pinnatifida with a moisture content of 2%-5%, and then sieving to obtain a Crataegus pinnatifida powder; adding an ethanol solution into the Crataegus pinnatifida powder to obtain a Crataegus pinnatifida solution, a volume fraction of the ethanol solution being 65%-75% and a mass of the ethanol solution being 10-50 times that of the Crataegus pinnatifida powder; performing ultrasonic extraction on the Crataegus pinnatifida solution 2-3 times at a temperature of 40-80 degrees Celsius (° C.), each of the 2-3 times corresponding to a time for ultrasonic extraction of 5-15 minutes, and then filtering to obtain filtrates; and combining the filtrates, and concentrating the filtrates to obtain the Crataegus pinnatifida flavone.
obtaining and combining tea-leaf, tea seed shell, water hyacinth, petiole of dasheen, the Rosa rugosa polysaccharides, and the Crataegus pinnatifida flavone to thereby obtain the tea.

In an embodiment, the tea further includes chitosan and fructo-oligosaccharide.

In an embodiment, the chitosan is 1-5 parts by weight and the fructo-oligosaccharide is 1-4 parts by weight.

Compared with the prior art, the beneficial effects of the disclosure are as follows.

(1) The fructo-oligosaccharide used in the disclosure is not easily absorbed by the human bodies and can significantly improve the proportion of microbial population in the intestine. The fructo-oligosaccharide is an activating and proliferating factor of bifidobacterium in the intestine, which can reduce and inhibit the production of spoilage substances in the intestine, inhibit the growth of harmful bacterium, and regulate intestinal balance.

(2) The tea of the disclosure adopts pure natural medicines without adding any toxic additives or addictive drugs, does not inhibit appetite, does not cause diarrhea, has no toxic side effects, is not addictive, has the functions of eliminating blood endotoxin content, increases the body's immune system, improves the gastrointestinal microbiota environment, and blocks and reduces the generation of free radicals.

### DETAILED DESCRIPTION OF EMBODIMENTS

In order to facilitate a better understanding of the disclosure by those skilled in the art, the following is a clear and complete description of the technical solutions in the embodiments of the disclosure. Apparently, the described embodiments are only a part of the embodiments of the disclosure, not all of them. Based on the embodiments in the disclosure, all other embodiments obtained by those skilled in the art without creative labor shall fall within the scope of protection of the disclosure.

### Embodiment 1

A tea for weight loss and lipid-lowering includes 850 g of tea-leaf, 10 g of tea seed shell, 10 g of water hyacinth, 10 g of petiole of dasheen, 10 g of Rosa rugosa polysaccharides, 20 g of Crataegus pinnatifida flavone, 10 g of chitosan and 10 g of fructo-oligosaccharide.

A preparation method of Rosa rugosa polysaccharides includes steps as follows:
Rosa rugosa is degreased, polysaccharides are extracted from the Rosa rugosa after the degreasing to obtain a polysaccharide extraction solution, then a solid-liquid separation is performed on the polysaccharide extraction solution to obtain an aqueous solution of Rosa rugosa polysaccharide, and the aqueous solution of Rosa rugosa polysaccharide is dried to obtain the Rosa rugosa polysaccharides.

A preparation method of Crataegus pinnatifida flavone includes steps as follows:
Crataegus pinnatifida with a moisture content of 2% is freezed and crushed, and then sieved to obtain a Crataegus pinnatifida powder, an ethanol solution is added into the Crataegus pinnatifida powder to obtain a Crataegus pinnatifida solution, a volume fraction of the ethanol solution being 65% and a mass of the ethanol solution being 10 times that of the Crataegus pinnatifida powder; an ultrasonic extraction is performed on the Crataegus pinnatifida solution 2 times at a temperature of 40° C., each of the 2 times corresponding to a time for ultrasonic extraction of 5 minutes, and then filtered to obtain filtrates, and followed by combining the filtrates, and concentrating the filtrates to obtain the Crataegus pinnatifida flavone.

### Embodiment 2

A tea for weight loss and lipid-lowering includes 950 g of tea-leaf, 80 g of tea seed shell, 50 g of water hyacinth, 30 g of petiole of dasheen, 40 g of Rosa rugosa polysaccharides, 60 g of Crataegus pinnatifida flavone, 40 g of chitosan and 40 g of fructo-oligosaccharide.

A preparation method of Rosa rugosa polysaccharides includes steps as follows:
Rosa rugosa is degreased, polysaccharides are extracted from the Rosa rugosa after the degreasing to obtain a polysaccharide extraction solution, then a solid-liquid separation is performed on the polysaccharide extraction solution to obtain an aqueous solution of Rosa rugosa polysaccharide, and the aqueous solution of Rosa rugosa polysaccharide is dried to obtain the Rosa rugosa polysaccharides.

A preparation method of Crataegus pinnatifida flavone includes steps as follows:
Crataegus pinnatifida with a moisture content of 5% is freezed and crushed, and then sieved to obtain a Crataegus pinnatifida powder, an ethanol solution is added into the Crataegus pinnatifida powder to obtain a Crataegus pinnatifida solution, a volume fraction of the ethanol solution being 75% and a mass of the ethanol solution being 50 times that of the Crataegus pinnatifida powder; an ultrasonic extraction is performed on the Crataegus pinnatifida solution 3 times at a temperature of 80° C., each of the 3 times corresponding to a time for ultrasonic extraction of 15 minutes, and then filtered to obtain filtrates, and followed by combining the filtrates, and concentrating the filtrates to obtain the Crataegus pinnatifida flavone.

The following experiments and raw materials of the disclosure are commissioned by the applicant Shen Yao to be completed by (Xianghe) Technology Co., Ltd.

### Experiments

Experimental group 1: green tea is purchased from the market, green tea is crushed and then are sieved by an 80-mesh sieve.

Experimental group 2:850 g of tea-leaf, 10 g of tea seed shell, 10 g of water hyacinth, 10 g of petiole of dasheen, 10 g of Rosa rugosa polysaccharides, 20 g of Crataegus pinnatifida flavone, 10 g of chitosan and 10 g of fructo-oligosaccharide are crushed respectively, and then are sieved by the 80-mesh sieve.

Experimental methods: healthy Kunming mice with a number of males and a number of females equaled, weighing 18-22 g are taken to group randomly: a blank control group, a model group, an experimental group 1 and an experimental group 2, each group includes 10 Kunming mice with a number of males and a number of females equaled. The mice of the blank control group are fed by standard diet for 30 days in a row, the mice of other groups are fed by high-fat diet 30 days in a row. From the 31st day, the mice of the experimental group 1 and the experimental group 2 are fed with the crushed green tea and the crushed tea for weight loss and lipid-lowering, an amount of applying a dosage is 1.5 grams per kilogram (g/kg) for 30 days in a row, once a day. The blank control group and the model group are fed with normal saline weighing the same as the dosage of the crushed green tea and the crushed tea for 30 days in a row. After 12 hours of the last applying, the weights of the mice are recorded in Table 1. Then the mice are fasted for 12 hours to take blood from the orbit of the mice to measure levels of low-density lipoprotein cholesterol (LDL-C), high density lipoprotein cholesterol (HDL-C), totalcholesterol (TC), and triglyceride (TG) in serum, the experimental results are recorded in Table 2. Note: the high-fat diet is 70% of standard diet, 10% of lard, 10% of protein powder, and 10% of fish liver oil.

TABLE 1
Effects on body weight of mice

| | Weight | Weight | Weight |
|---|---|---|---|
| Group | of 0 day | of 30 day | of 60 day |
| Blank control group | 18.47 ± 0.91 | 29.47 ± 1.94 | 36.10 ± 1.91 |
| Model group | 18.97 ± 0.71 | 35.28 ± 2.41 | 43.47 ± 3.71 |
| Experimental group 1 | 18.57 ± 0.91 | 36.74 ± 3.11 | 41.27 ± 2.31 |
| Experimental group 2 | 18.68 ± 0.91 | 34.47 ± 2.11 | 38.94 ± 0.91 |

Note:
compared with the blank control group, **P < 0.01; compared with the model group, ##P < 0.01, #P < 0.05.

TABLE 2
Effects on blood fat of mice

| Group | TGmmol/L | TGmmol/L | TGmmol/L | TGmmol/L |
|---|---|---|---|---|
| Blank control group | 0.81 ± 0.17 | 1.50 ± 0.24 | 0.09 ± 0.05 | 1.54 ± 0.38 |
| Model group | 1.52 ± 0.44 | 1.02 ± 0.22 | 0.58 ± 0.12 | 2.49 ± 0.25 |
| Experimental group 1 | 0.96 ± 0.21 | 1.24 ± 0.24 | 0.45 ± 0.25 | 2.07 ± 0.59 |
| Experimental group 2 | 0.82 ± 0.21 | 1.62 ± 0.26 | 0.14 ± 0.07 | 1.70 ± 0.56 |

Note:
compared with the model group, ** P < 0.01, P < 0.05.

Experimental conclusion: Under the same dosage, the commercially available green tea group has a weight reduction effect on mice, but there was no statistical significance. However, the tea added with the tea seed shell, the water hyacinth, and the petiole of dasheen has a significant effect on weight reduction on mice, with a significant difference compared to the model group (P<0.05). Similarly, in terms of the lipid-lowering, tea added with the tea seed shell, the water hyacinth, and the petiole of dasheen has a significant regulatory effect on blood lipids, with a significant difference compared to the model group (P<0.01). Experimental research has shown that the tea set of the disclosure has a very good effect on weight loss and lipid-lowering.

Apparently, the above embodiments are only for the purpose of clearly illustrating the embodiments of the disclosure, rather than limiting the embodiments of the disclosure. The purpose is to enable those familiar with this technology to understand the content of the disclosure and implement it accordingly, and does not limit the scope of protection of the disclosure. Any modifications, equivalent substitutions, and improvements made within the spirit and principles of the disclosure shall be included within the scope of protection of the claims of the disclosure.

What is claimed is:

1. A tea for weight loss and lipid-lowering, comprising:
85-95 parts by weight of tea-leaf, 1-8 parts by weight of tea seed shell, 1-5 parts by weight of water hyacinth, 1-3 parts by weight of petiole of dasheen, 1-4 parts by weight of Rosa rugosa polysaccharides, and 2-6 parts by weight of Crataegus pinnatifida flavone.

2. The tea as claimed in claim 1, wherein the tea comprises: 85 parts by weight of the tea-leaf, 1 part by weight of the tea seed shell, 1 part by weight of the water hyacinth, 1 part by weight of the petiole of dasheen, 1 part by weight of the Rosa rugosa polysaccharides, and 2 parts by weight of the Crataegus pinnatifida flavone.

3. The tea as claimed in claim 1, wherein the tea comprises: 90 parts by weight of the tea-leaf, 4 parts by weight of the tea seed shell, 3 parts by weight of the water hyacinth, 2 parts by weight of the petiole of dasheen, 2 parts by weight of the Rosa rugosa polysaccharides, and 4 parts by weight of the Crataegus pinnatifida flavone.

4. The tea as claimed in claim 1, wherein the tea comprises 95 parts by weight of the tea-leaf, 8 parts by weight of the tea seed shell, 5 parts by weight of the water hyacinth, 3 parts by weight of the petiole of dasheen, 4 parts by weight of the Rosa rugosa polysaccharides, and 6 parts by weight of the Crataegus pinnatifida flavone.

5. The tea as claimed in claim 1, wherein the tea further comprises 1-5 parts by weight of chitosan and 1-4 parts by weight of fructo-oligosaccharide.

6. The tea as claimed in claim 5, wherein a weight ratio of the tea-leaf, the tea seed shell, the water hyacinth, the petiole of dasheen, the Rosa rugosa polysaccharides, the Crataegus pinnatifida flavone, the chitosan, and the fructo-oligosaccharide is 85:1:1:1:1:2:1:1.

7. The tea as claimed in claim 5, wherein a weight ratio of the tea-leaf, the tea seed shell, the water hyacinth, the petiole of dasheen, the Rosa rugosa polysaccharides, the Crataegus pinnatifida flavone, the chitosan, and the fructo-oligosaccharide is 95:8:5:3:4:6:5:4.

8. A preparation method of a tea for weight loss and lipid-lowering, comprising:
degreasing Rosa rugosa, extracting polysaccharides from the Rosa rugosa after the degreasing to obtain a polysaccharide extraction solution, performing a solid-liquid separation on the polysaccharide extraction solution to obtain an aqueous solution of Rosa rugosa polysaccharide, and drying the aqueous solution of Rosa rugosa polysaccharide to obtain the Rosa rugosa polysaccharides;
freezing and crushing Crataegus pinnatifida with a moisture content of 2%-5%, and then sieving to obtain a Crataegus pinnatifida powder; adding an ethanol solution into the Crataegus pinnatifida powder to obtain a Crataegus pinnatifida solution, a volume fraction of the ethanol solution being 65%-75% and a mass of the ethanol solution being 10-50 times that of the Crataegus pinnatifida powder; performing ultrasonic extraction on the Crataegus pinnatifida solution 2-3 times at a temperature of 40-80 degrees Celsius (° C.), each of the 2-3 times corresponding to a time for ultrasonic extraction of 5-15 minutes, and then filtering to obtain filtrates; and combining the filtrates, and concentrating the filtrates to obtain the Crataegus pinnatifida flavone; and
obtaining and combining 85-95 parts by weight of tea-leaf, 1-8 parts by weight of tea seed shell, 1-5 parts by weight of water hyacinth, 1-3 parts by weight of petiole of dasheen, 1-4 parts by weight of the Rosa rugosa polysaccharides, and 2-6 parts by weight of the Crataegus pinnatifida flavone to thereby obtain the tea.

9. The preparation method of the tea for weight loss and lipid-lowering as claimed in claim 8, wherein a weight ratio of the tea-leaf, the tea seed shell, the water hyacinth, the petiole of dasheen, the Rosa rugosa polysaccharides, and the Crataegus pinnatifida flavone is 85:1:1:1:1:2.

10. The preparation method of the tea for weight loss and lipid-lowering as claimed in claim 8, wherein a weight ratio of the tea-leaf, the tea seed shell, the water hyacinth, the petiole of dasheen, the Rosa rugosa polysaccharides, and the Crataegus pinnatifida flavone is 90:4:3:2:2:4.

11. The preparation method of the tea for weight loss and lipid-lowering as claimed in claim 8, wherein a weight ratio of the tea-leaf, the tea seed shell, the water hyacinth, the petiole of dasheen, the Rosa rugosa polysaccharides, and the Crataegus pinnatifida flavone is 95:8:5:3:4:6.

12. The preparation method of the tea for weight loss and lipid-lowering as claimed in claim 8, further comprising:
adding 1-5 parts by weight of chitosan and 1-4 parts by weight of fructo-oligosaccharide into the 85-95 parts by weight of the tea-leaf, the 1-8 parts by weight of the tea seed shell, the 1-5 parts by weight of the water hyacinth, the 1-3 parts by weight of the petiole of dasheen, the 1-4 parts by weight of the Rosa rugosa polysaccharides, and the 2-6 parts by weight of the Crataegus pinnatifida flavone to thereby obtain the tea.

13. The preparation method of the tea for weight loss and lipid-lowering as claimed in claim 12, wherein a weight ratio of the tea-leaf, the tea seed shell, the water hyacinth, the petiole of dasheen, the Rosa rugosa polysaccharides, the Crataegus pinnatifida flavone, the chitosan, and the fructo-oligosaccharide is 85:1:1:1:1:2:1:1.

14. The preparation method of the tea for weight loss and lipid-lowering as claimed in claim 12, wherein a weight ratio of the tea-leaf, the tea seed shell, the water hyacinth, the petiole of dasheen, the Rosa rugosa polysaccharides, the Crataegus pinnatifida flavone, the chitosan, and the fructo-oligosaccharide is 95:8:5:3:4:6:5:4.

15. The preparation method of the tea for weight loss and lipid-lowering as claimed in claim 8, wherein the moisture content is 2%, the volume fraction of the ethanol solution is 65%, the mass of the ethanol solution is 10 times that of the Crataegus pinnatifida powder, the ultrasonic extraction is performed twice, the temperature is 40° C., and the time for ultrasonic extraction is 5 minutes.

16. The preparation method of the tea for weight loss and lipid-lowering as claimed in claim 8, wherein the moisture content is 5%, the volume fraction of the ethanol solution is 75%, the mass of the ethanol solution is 50 times that of the Crataegus pinnatifida powder, the ultrasonic extraction is performed three times, the temperature is 80° C., and the time for ultrasonic extraction is 15 minutes.

17. A preparation method of a tea for weight loss and lipid-lowering comprising:
obtaining Rosa rugosa, and processing the Rosa rugosa to obtain Rosa rugosa polysaccharides from the Rosa rugosa;
obtaining Crataegus pinnatifida with a moisture content of 2%-5%, and extracting Crataegus pinnatifida flavone from the Crataegus pinnatifida;
combining 85-95 parts by weight of tea-leaf, 1-8 parts by weight of tea seed shell, 1-5 parts by weight of water hyacinth, 1-3 parts by weight of petiole of dasheen, 1-4 parts by weight of the Rosa rugosa polysaccharides, and 2-6 parts by weight of the Crataegus pinnatifida flavone to thereby obtain the tea.

18. The preparation method of the tea for weight loss and lipid-lowering as claimed in claim 17, further comprising:
adding 1-5 parts by weight of chitosan and 1-4 parts by weight of fructo-oligosaccharide into the 85-95 parts by weight of the tea-leaf, the 1-8 parts by weight of the tea seed shell, the 1-5 parts by weight of the water hyacinth, the 1-3 parts by weight of the petiole of dasheen, the 1-4 parts by weight of the Rosa rugosa polysaccharides, and the 2-6 parts by weight of the Crataegus pinnatifida flavone to obtain the tea.

19. The preparation method of the tea for weight loss and lipid-lowering as claimed in claim 17, wherein the processing the Rosa rugosa to obtain Rosa rugosa polysaccharides from the Rosa rugosa comprises:
degreasing the Rosa rugosa, extracting polysaccharides from the Rosa rugosa after the degreasing to obtain a polysaccharide extraction solution, then performing a solid-liquid separation on the polysaccharide extraction solution to obtain an aqueous solution of Rosa rugosa polysaccharide, and drying the aqueous solution of Rosa rugosa polysaccharide to obtain the Rosa rugosa polysaccharides.

20. The preparation method of the tea for weight loss and lipid-lowering as claimed in claim 17, wherein the extracting Crataegus pinnatifida flavone from the Crataegus pinnatifida comprises:
freezing and crushing the Crataegus pinnatifida, then sieving to obtain a Crataegus pinnatifida powder, adding an ethanol solution into the Crataegus pinnatifida powder to obtain a Crataegus pinnatifida solution, a volume fraction of the ethanol solution is 65%-75% and a mass of the ethanol solution is 10-50 times that of the Crataegus pinnatifida powder; performing ultrasonic extraction on the Crataegus pinnatifida solution 2-3 times at a temperature of 40-80° C. for 5-15 minutes, and then filtering to obtain filtrates, combining the filtrates, and concentrating the filtrates to obtain the Crataegus pinnatifida flavone.
